(19) United States
(12) Patent Application Publication
(10) Pub. No.: US 2015/0030006 A1
(43) Pub. Date: Jan. 29, 2015

(54) RADIO BASE STATION AND CHANNEL ESTIMATION METHOD

(71) Applicant: FUJITSU LIMITED, Kawasaki-shi (JP)

(72) Inventors: Shunsuke FUJIO, Kawasaki (JP); Dai KIMURA, Yokohama (JP)

(21) Appl. No.: 14/339,212

(22) Filed: Jul. 23, 2014

(30) Foreign Application Priority Data
Jul. 26, 2013 (JP) 2013-155129

(51) Int. Cl. H04B 7/04; H04W 72/08; H04W 72/04

(52) U.S. Cl. CPC H04B 7/0456; H04W 72/042; H04W 72/082
USPC 370/336

(57) ABSTRACT

A radio base station including: a processor configured to precode a first reference signal based on a first precoding matrix and a second reference signal based on a second precoding matrix, transmit the precoded first reference signal using a first radio resource and the precoded second reference signal using a second radio resource, to a radio terminal, receive first channel state information and second channel state information from the radio terminal, the first channel state information indicating a first channel estimated at the radio terminal based on the precoded first reference signal, the second channel state information indicating a second channel estimated at the radio terminal based on the precoded second reference signal, and estimate a downlink channel between the radio base station and the radio terminal based on the first channel state information, the second channel state information, the first precoding matrix, and the second precoding matrix.

### CROSS-REFERENCE TO RELATED APPLICATION

This application is based upon and claims the benefit of priority of the prior Japanese Patent Application No. 2013-155129, filed on Jul. 26, 2013, the entire contents of which are incorporated herein by reference.

### FIELD

The embodiments discussed herein are related to a radio base station.

### BACKGROUND

In Long Term Evolution-Advanced (LTE-A), a terminal may receive two kinds of reference signals that are a channel state information-reference signal (CSI-RS) and a demodulation-reference signal (DM-RS). The CSI-RS is a reference signal for CSI measurement, which is common to all terminals. The DM-RS is a reference signal for data demodulation, which is unique to the terminal. A base station applies the same precoding to both of a data signal and the DM-RS in downlink communication and thereby enables desired precoding by the base station without notifying each of the terminals of a precoding matrix.

Japanese Laid-open Patent Publication No. 2011-147069 and Japanese Laid-open Patent Publication No. 2012-80522 are examples of related art.

### SUMMARY

According to an aspect of the invention, a radio base station includes a memory, and a processor coupled to the memory and configured to precode a first reference signal based on a first precoding matrix and a second reference signal based on a second precoding matrix, transmit the precoded first reference signal using a first radio resource and the precoded second reference signal using a second radio resource, to a radio terminal, receive first channel state information and second channel state information from the radio terminal, the first channel state information indicating a first channel estimated at the radio terminal based on the precoded first reference signal, the second channel state information indicating a second channel estimated at the radio terminal based on the precoded second reference signal, and estimate a downlink channel between the radio base station and the radio terminal based on the first channel state information, the second channel state information, the first precoding matrix, and the second precoding matrix.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 illustrates an example of a base station and terminals;

FIG. 2 illustrates a configuration example of a system according to a first embodiment;

FIG. 3 illustrates an example of function blocks of the base station according to the first embodiment;

FIG. 4 illustrates a hardware configuration example of the base station;

FIG. 5 illustrates an example of function blocks of the terminal according to the first embodiment;

FIG. 6 illustrates a hardware configuration example of the terminal;

FIG. 7 illustrates an example of an operation sequence between a base station and a terminal;

FIG. 8 illustrates code rates and modulation schemes of 16 kinds of channel quality indicator (CQI) in LTE-A;

FIG. 9 illustrates an example of a codebook;

FIG. 10 illustrates an example of a subframe subset;

FIG. 11 illustrates an example of an operation sequence between the base station and the terminal;

FIG. 12 illustrates an example of function blocks of a base station according to a third embodiment;

FIG. 13 illustrates examples of communication resource groups and precoding matrices;

FIG. 14 illustrates an example of function blocks of a terminal according to the third embodiment;

FIG. 15 illustrates an example (1) of an operation sequence between a base station and a terminal;

FIG. 16 illustrates an example (2) of the operation sequence between the base station and the terminal; and

FIG. 17 illustrates an example (3) of the operation sequence between the base station and the terminal.

### DESCRIPTION OF EMBODIMENTS

Embodiments of the present disclosure are hereinafter described with reference to drawings. Configurations of the embodiments are merely illustrative, and configurations of the present disclosure are not limited to specific configurations of the embodiments of the present disclosure. Specific configurations according to the embodiments may appropriately be employed in carrying out the configurations of the present disclosure.

A description is herein made with LTE-A as an example. However, the embodiments of the present disclosure may be applied to other communication methods.

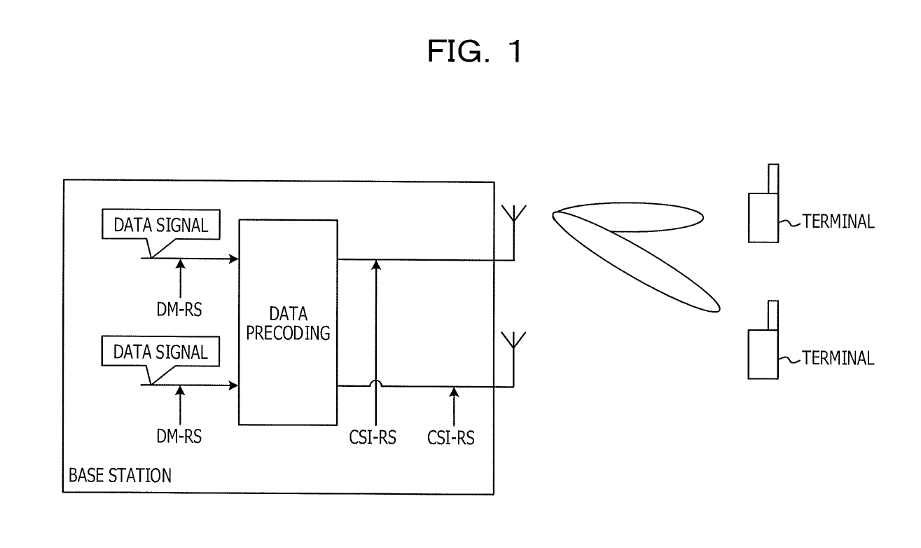

FIG. 1 illustrates an example of a base station and terminals. In the example of FIG. 1, two terminals are connected with the base station. The base station in FIG. 1 applies the same precoding to both of a data signal and a DM-RS.

In multiuser-multiple input multiple output (MU-MIMO) transmission where a plurality of terminals are spatially multiplexed, the base station transmits a signal by using appropriate precodings corresponding to downlink channels for the multiplexed terminals. This may reduce interference among the multiplexed terminals. In order to determine an appropriate precoding, information about a downlink channel is used. However, because uplink channels are different from downlink channels in a frequency division duplexing (FDD) method, the base station is desired to estimate downlink channel information based on feedback from the terminals.

As a technology of channel estimation, a method in which the channel estimation is performed by the base station by using a precoding matrix indicator (PMI) included in CSI fed back by the terminal has been used. Here, the PMI is an index value in the codebook, which indicates a precoding vector desired by the terminal. In related art, it is possible to estimate an equivalent channel between a stream passed through a receiving filter such as a minimum mean square error (MMSE) filter and each transmission antenna based on the PMI during transmission of a single stream.

For example, there is a technique for calculating a precoding matrix for a data signal based on a value reported from the terminal. In the technique, the terminal reports not the PMI but a channel direction indicator (CDI) resulting from quantization of an equivalent channel after passage through the receiving filter. However, this technique is similar to the PMI in the point that information that is determined in advance by the codebook is reported and the downlink channel estimation is performed based on the information by the base station.

In related art, a limit of channel estimation accuracy is determined in accordance with the size of the codebook (kinds (number) of precoding vectors in the codebook). In order to perform the channel estimation at higher accuracy, a codebook of a larger size may be used, for example. However, when the codebook of a large size is used, an amount of computation for the channel estimation at the terminal increases, and the number of bits that are used for one report increases. In a case where the size of the codebook is made larger, the number of bits that are used for one report may be reduced by performing the report while splitting all the bits to be reported into plural groups. However, because reports are made a plurality of times for one channel estimation, a cycle of updating channel information is delayed.

It is desirable to improve the accuracy of downlink channel estimation while maintaining the size of the codebook.

### First Embodiment

Here, a description is made about an example where, in LTE-A, a base station that includes two antennas transmits the CSI-RS by two kinds of precodings and the channel estimation is performed by using the CSI fed back by a terminal that includes one antenna. The two kinds of precodings are a precoding #A (precoding matrix U_{A}) and a precoding #B (precoding matrix U_{B}). Here, the base station applies temporally-different precodings to the CSI-RS. That is, for example, the base station precodes the CSI-RS with the precoding matrix U_{A} in a first period and precodes the CSI-RS with the precoding matrix U_{B} in a second period. Further, the base station performs the channel estimation based on the CSI that is fed back from the terminal while taking into account the precoding (precoding matrix) applied to the CSI-RS. The CSI includes a channel quality indicator (CQI) that indicates a channel quality and the PMI that represents the precoding vector desired by the terminal.

### Configuration Example 1

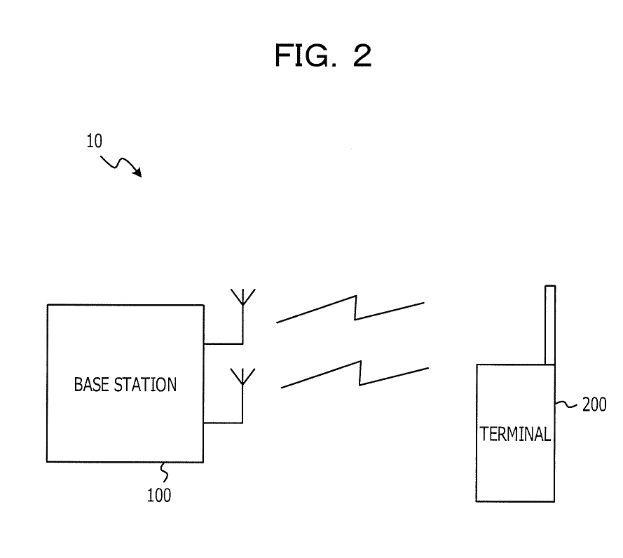

FIG. 2 illustrates a configuration example of a system according to the first embodiment. A system 10 in FIG. 2 includes a base station 100 and a terminal 200. The terminal 200 is present in an area where the terminal 200 and the base station 100 are able to perform mutual radio communication. A plurality of terminals may be present in the area where the terminals and the base station 100 are able to perform mutual radio communication. The base station 100 is connected with a higher-level device that is not illustrated. The base station 100 is an example of a radio base station.

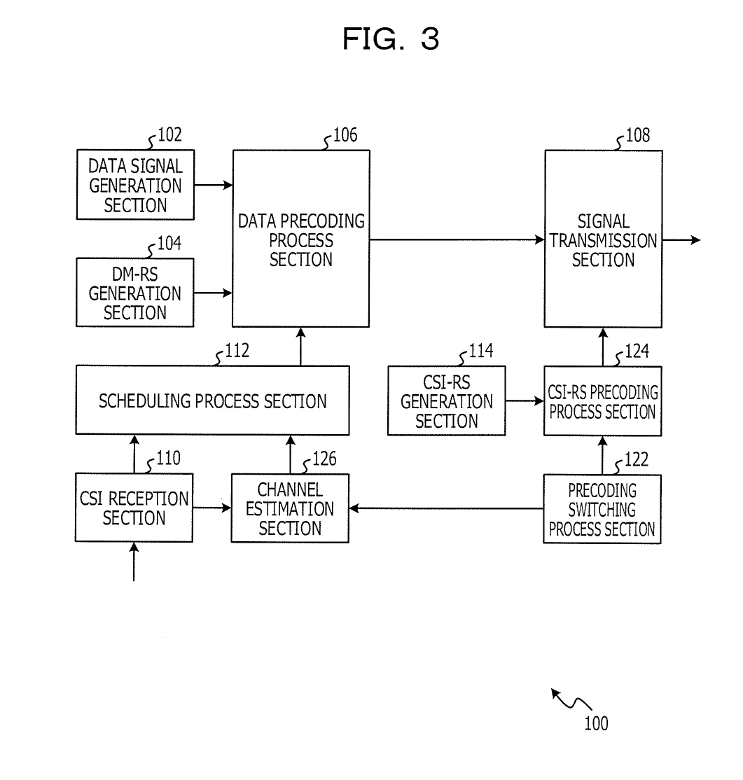

FIG. 3 illustrates an example of function blocks of the base station according to this embodiment. The base station 100 includes a data signal generation section 102, a DM-RS generation section 104, a data precoding process section 106, a signal transmission section 108, a CSI reception section 110, a scheduling process section 112, and a CSI-RS generation section 114. Further, the base station 100 includes a precoding switching process section 122, a CSI-RS precoding process section 124, and a channel estimation section 126.

The data signal generation section 102 generates a data signal addressed to the terminal. The generated data signal is output to the data precoding process section 106.

The DM-RS generation section 104 generates the DM-RS that is unique to the terminal. The generated DM-RS is output to the data precoding process section 106.

The data precoding process section 106 performs a precoding process on the data signal generated by the data signal generation section 102 and the DM-RS generated by the DM-RS generation section 104 by using a precoding matrix determined by the scheduling process section 112.

The signal transmission section 108 transmits the CSI-RS to which the precoding process is applied by the CSI-RS precoding process section 124 toward the terminal 200. The signal transmission section 108 transmits the data signal and the DM-RS that result from application of the precoding process at the data precoding process section 106 toward the terminal 200. The signal transmission section 108 is an example of a transmission section.

The CSI reception section 110 performs a process of receiving CSI that is reported from the terminal 200. The CSI reception section 110 notifies the scheduling process section 112 and the channel estimation section 126 of the received CSI. The CSI reception section 110 is an example of a reception section.

The scheduling process section 112 allocates resources to the terminal 200 based on the CSI reported from the terminal 200 and the information about a downlink channel estimated by the channel estimation section 126. Here, the scheduling process section 112 may allocate the same resources to a plurality of terminals in consideration of implementation of MU-MIMO. Further, the scheduling process section 112 determines the precoding matrix to be applied to the data signal, based on the information about the downlink channel that is estimated by the channel estimation section 126.

The CSI-RS generation section 114 generates a CSI-RS that is used for CSI measurement and common to all the terminals.

The precoding switching process section 122 switches the precoding matrices that are used by the CSI-RS precoding process section 124. The precoding switching process section 122 provides the channel estimation section 126 with information about the precoding matrix at transmission of the CSI-RS. The channel estimation section 126 is notified of information such as periods and bands in which the respective CSI-RS with the applied precoding matrices are transmitted.

The CSI-RS precoding process section 124 performs the precoding process on the CSI-RS. The CSI-RS precoding process section 124 is an example of a precoding process section.

The channel estimation section 126 performs a downlink channel estimation based on the CSI reported from the terminal and the information about the precoding matrix given from the precoding switching process section 122.

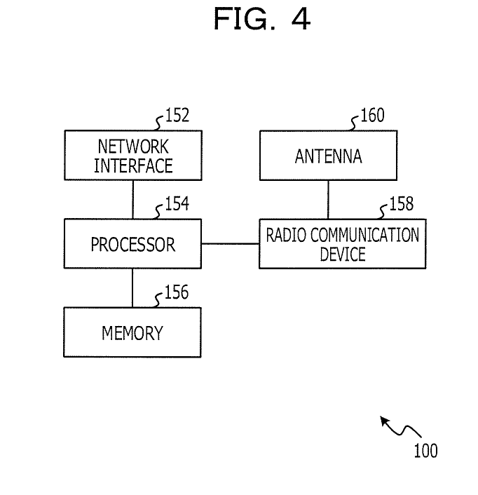

FIG. 4 illustrates a hardware configuration example of the base station. The base station 100 in FIG. 4 includes a network interface 152, a processor 154, a memory 156, a radio communication device 158, and an antenna 160.

The network interface 152 is an interface for connecting the base station 100 with a higher-level network. The base station 100 is connected with the higher-level device via the network interface 152.

The processor 154 performs execution of a program, memory management, and so forth. The processor 154 performs processes such as various computation, calculation, and control according to a program and an input from an input unit and so forth. Further, the processor 154 loads program content and data into the memory 156.

The memory 156 includes a random access memory (RAM) and a read only memory (ROM), for example. The program and the data to be used by the processor 154 are loaded into the memory 156.

The radio communication device 158 is an interface for wireless connection with wireless units and so forth such as the terminal 200. The radio communication device 158 is connected with the antenna 160. The radio communication device 158 converts an electrical signal that is input from the processor 154 into a radio signal and transmits the radio signal via the antenna 160. The radio communication device 158 converts a radio signal that is received via the antenna 160 into an electrical signal and outputs the electrical signal to the processor 154.

The antenna 160 receives radio signals that are transmitted from another wireless unit such as the terminal 200. Further, the antenna 160 transmits a radio signal to be transmitted to another wireless unit such as the terminal 200.

The hardware configuration of the base station 100 is not limited to the example illustrated in FIG. 4, but appropriate change such as addition, substitution, and removal may be conducted.

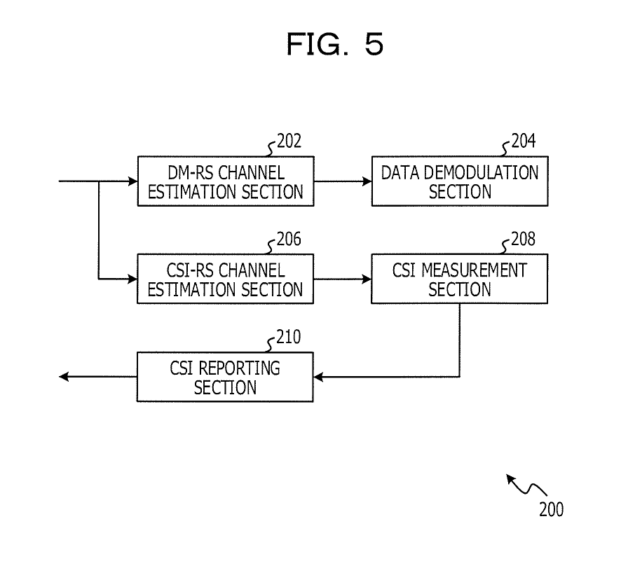

FIG. 5 illustrates an example of function blocks of the terminal according to this embodiment. The terminal 200 in FIG. 5 includes a DM-RS channel estimation section 202, a data demodulation section 204, a CSI-RS channel estimation section 206, a CSI measurement section 208, and a CSI reporting section 210.

The DM-RS channel estimation section 202 performs a downlink channel estimation based on the DM-RS that is received from the base station 100.

The data demodulation section 204 performs demodulation of the data that is received from the base station 100 based on the channel information that is estimated by the DM-RS channel estimation section 202.

The CSI-RS channel estimation section 206 performs a downlink channel estimation based on the CSI-RS that is received from the base station 100.

The CSI measurement section 208 determines the CSI based on the channel information that is estimated by the CSI-RS channel estimation section 206.

The CSI reporting section 210 reports the CSI that is determined by the CSI measurement section 208 to the base station 100.

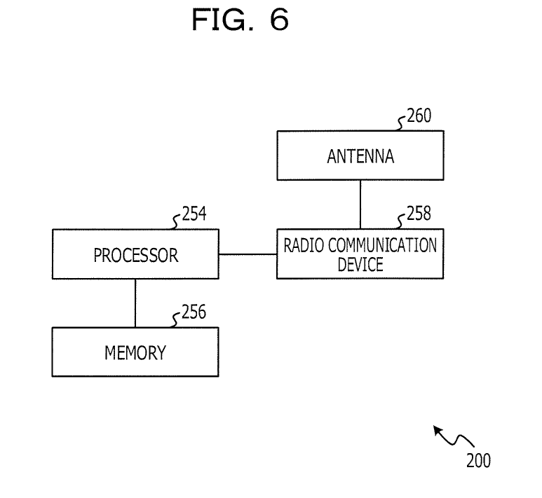

FIG. 6 illustrates a hardware configuration example of the terminal. The terminal 200 in FIG. 6 includes a processor 254, a memory 256, a radio communication device 258, and an antenna 260.

The processor 254 performs execution of a program, memory management, and so forth. The processor 254 performs processes such as various computation, calculation, and control according to a program and an input from an input unit and so forth. Further, the processor 254 loads program content and data into the memory 256.

The memory 256 is a RAM or a ROM, for example. The program and the data to be used by the processor 254 are loaded into the memory 256. The memory 256 may store the codebook.

The radio communication device 258 is an interface for wireless connection with wireless units and so forth such as the base station 100. The radio communication device 258 is connected with the antenna 260. The radio communication device 258 converts an electrical signal that is input from the processor 254 into a radio signal and transmits the radio signal via the antenna 260. The radio communication device 258 converts a radio signal that is received via the antenna 260 into an electrical signal and outputs the electrical signal to the processor 254.

The antenna 260 receives radio signals that are transmitted from another wireless unit such as the base station 100. Further, the antenna 260 transmits a radio signal to be transmitted to another wireless unit such as the base station 100.

The hardware configuration of the terminal 200 is not limited to the example illustrated in FIG. 6, but appropriate change such as addition, substitution, and removal may be conducted.

The base station 100 may be implemented by using a general purpose computer or a dedicated computer such as a server machine. The terminal 200 may be implemented by using a dedicated or general purpose computer such as a PC or a personal digital assistant (PDA) or electronic equipment that has a computer installed therein. Further, the terminal 200 may be implemented by using a dedicated or general purpose computer such as a smart phone, a cellular phone, a tablet terminal, or an automotive navigation system or electronic equipment that has a computer installed therein.

A computer, that is, an information processing apparatus includes a processor, a main memory and a secondary memory, and an interface unit such as a communication interface unit that interfaces with peripheral apparatuses. The main memory and the secondary memory are computer-readable recording media.

The processor loads a program stored in the recording medium to a work area of the main memory and executes the program, the peripheral units are controlled via the execution of the program, and the computer may thereby implement a function that corresponds to a certain purpose.

The processor is a central processing unit (CPU) or a digital signal processor (DSP), for example. The main memory includes a RAM or a ROM, for example.

The secondary memory is an erasable programmable ROM (EPROM) or a hard disk drive (HDD), for example. Further, the secondary memory may include a removable medium, that is, a portable recording medium. The removable media are a universal serial bus (USB) memory or disc recording media such as a compact disc (CD) and a digital versatile disc (DVD), for example.

The communication interface unit is a local area network (LAN) interface board or a radio communication circuit for radio communication, for example.

The peripheral units include an input unit and an output unit in addition to the secondary memory and the communication interface unit. The input unit includes a keyboard, a pointing device, a wireless remote controller, and so forth. Further, the input unit may include an input unit for video and images such as a camera and an input unit for sounds such as a microphone. The output unit includes a cathode ray tube (CRT) display, a liquid crystal display (LCD), a plasma display panel (PDP), an electroluminescence (EL) panel, a printer, and so forth. Further, the output unit may include an output unit for sounds such as a speaker.

The processor loads a program stored in the secondary memory to the main memory and executes the program, and thereby the computer that implements the base station 100 may realize a function of each function block. The program, data, and so forth to be used by the base station 100 may be stored in the main memory and the secondary memory of the computer that implements the base station 100.

The processor loads a program stored in the secondary memory to the main memory and executes the program, and thereby the computer that implements the terminal 200 may realize a function of each function block. The program, data, and so forth to be used by the terminal 200 may be stored in the main memory and the secondary memory of the computer that implements the terminal 200.

### Operation Example 1

The base station 100 transmits the CSI-RS with the applied precoding matrix to the terminal 200. The terminal 200 determines the CSI to be reported to the base station 100 based on the received CSI-RS and transmits the CSI to the base station 100. The base station 100 performs the channel estimation based on the precoding matrix that is applied to the CSI-RS and the CSI. The CSI-RS is an example of a reference signal.

Here, a description is made about an operation example 1 between the base station 100 and the terminal 200. In the operation example 1, the base station 100 switches the precoding matrices to be applied to the CSI-RS in the time direction (time axis direction).

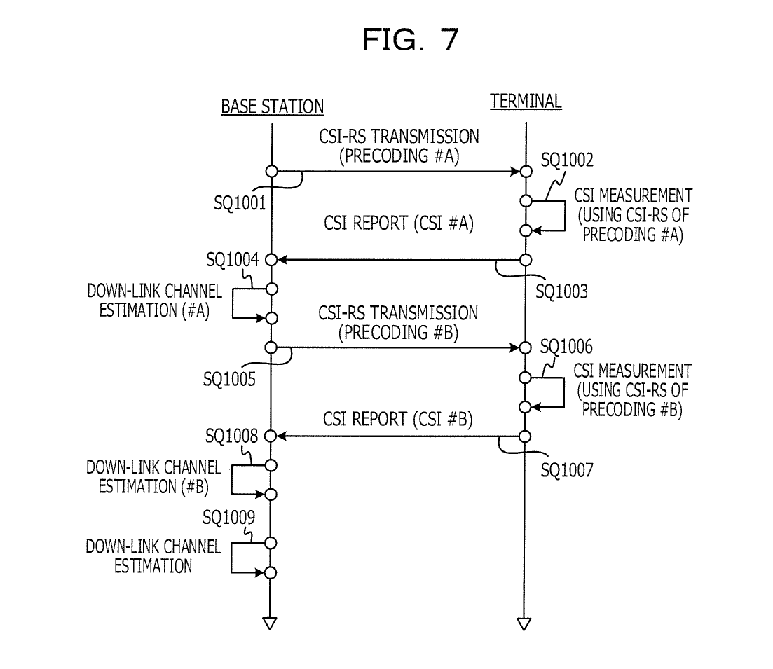

FIG. 7 illustrates an example of an operation sequence between the base station 100 and the terminal 200.

The precoding switching process section 122 of the base station 100 determines the precoding matrix to be applied to the CSI-RS. Here, the precoding switching process section 122 determines the precoding matrix U_{A} that is represented by the following expression as the precoding matrix to be applied to the CSI-RS in a predetermined first period. The precoding switching process section 122 notifies the CSI-RS precoding process section 124 of the determined precoding matrix U_{A}.

$${U}_{A} = ( \begin{matrix}1 & 0 \\ 0 & exp ( j {φ}_{A} )\end{matrix} ) \qquad [ Expression 1 ]$$

The CSI-RS generation section 114 generates the CSI-RS to be transmitted to the terminal 200. The CSI-RS is common to all the terminals and is used for the CSI measurement at each of the terminals. The CSI-RS generation section 114 transmits the generated CSI-RS to the CSI-RS precoding process section 124.

The CSI-RS precoding process section 124 applies the precoding matrix U_{A} that is determined by the precoding switching process section 122 to the CSI-RS that is generated by the CSI-RS generation section 114. The CSI-RS precoding process section 124 transmits the CSI-RS with the applied precoding matrix U_{A} to the signal transmission section 108.

The signal transmission section 108 transmits the CSI-RS with the applied precoding matrix U_{A} to the terminal 200 in the first period (SQ1001).

The CSI-RS channel estimation section 206 of the terminal 200 receives the CSI-RS with the applied precoding matrix U_{A} from the base station 100. The CSI-RS channel estimation section 206 performs the channel estimation based on the received signal.

The terminal 200 recognizes that the CSI-RS is orthogonally transmitted from each transmission antenna of the base station 100. The terminal 200 estimates the channel between each of the transmission antennas of the base station 100 and a reception antenna of the terminal 200 on the premise that the CSI-RS is orthogonally transmitted. A reception signal ri of the terminal for a signal si that is transmitted from a transmission antenna #i of the base station 100 is represented by the following expression.

rᵢ=hᵢsᵢ+n [Expression 2]

Here, hi represents the channel between the transmission antenna #i and the reception antenna of the terminal 200. n represents noise. Because the CSI-RS is a known signal, the terminal 200 may perform the channel estimation by the following expression, for example.

\tilde{h}ᵢ=sᵢ⁻¹·rᵢ=hᵢ+sᵢ⁻¹·n [Expression 3]

Here,

\tilde{h}ᵢ [Expression 4]

Expression 4 represents the channel, which is estimated by the terminal 200, between the transmission antenna #i and the reception antenna of the terminal 200.

The CSI-RS channel estimation section 206 of the terminal 200 calculates a signal to noise ratio (SNR) of all the precoding vectors that are described in the codebook in a case where data transmission is performed with the precoding vectors.

A reception signal yj at the terminal in a case where the base station 100 transmits a data signal x with a precoding vector vj that is represented by a precoding matrix indicator (PMI) #j is represented by the following expression.

yⱼ=H₀vⱼx+n [Expression 5]

Here, n represents noise. H₀ is an actual downlink channel and is represented as follows:

H₀=(h₁h₂) [Expression 6]

When transmission signal power is Es and noise power is σ², the signal to noise ratio (SNR) γj of the reception signal yj is represented by the following expression.

$${γ}_{j} = \frac{{\vert {H}_{0} {v}_{j} \vert}^{2} {E}_{s}}{{σ}^{2}} \qquad [ Expression 7 ]$$

The power of the transmission signal is in advance reported from the base station 100 to the terminal 200. Thus, the terminal 200 may estimate the SNR in a case where the base station 100 transmits the data signal with the precoding vector vj that is represented by the PMI #j by the following expression based on information of the estimated channel.

$$\begin{matrix}{\tilde{γ}}_{j} = \frac{{\vert {\tilde{H}}_{0} {v}_{j} \vert}^{2} {E}_{s}}{{σ}^{2}} \\ {\tilde{H}}_{0} = ( {\tilde{h}}_{1} {\tilde{h}}_{2} )\end{matrix} \qquad [ Expression 8 ]$$

Here,

\tilde{γ}ⱼ [Expression 9]

Expression 9 is an estimated value of the SNR by the terminal 200. In order to obtain the PMI that maximizes the SNR, the terminal 200 calculates Expression 10.

\tilde{γ}ⱼ [Expression 10]

for all the PMIs.

After the SNR is calculated for each of the PMIs, the terminal 200 selects the PMI that maximizes the SNR as a desired PMI. A desired PMI #j′ is given by the following expression based on the estimated SNR.

$${j}^{′} = arg {max }_{j} {\tilde{γ}}_{j} \qquad [ Expression 11 ]$$

After the desired PMI is determined, the terminal 200 determines the CQI based on the following expression that corresponds to the desired PMI #j′.

\tilde{γ}_{j′} [Expression 12]

In LTE-A, 16 kinds of CQI that are #0 to #15 are configured, and respective code rates and modulation schemes are determined for the 16 kinds of CQI.

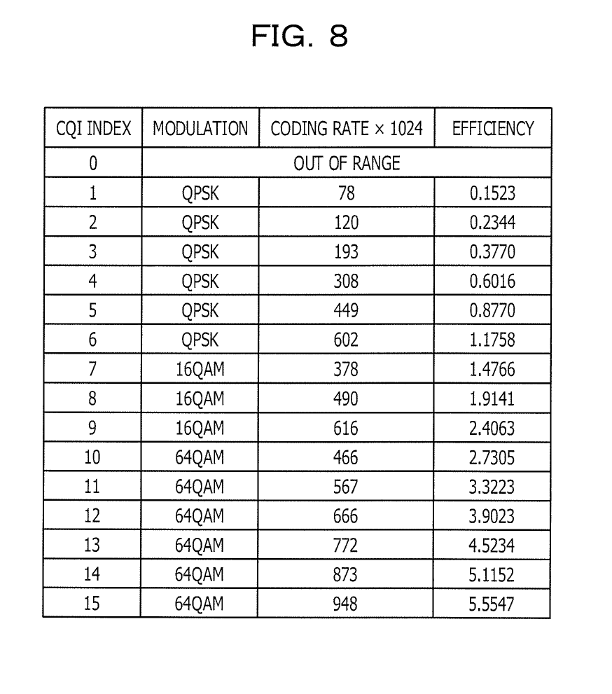

FIG. 8 illustrates the code rates and modulation schemes of 16 kinds of CQI in LTE-A.

Taking into account reception performance of the terminal 200 itself, the terminal 200 selects the CQI with a combination of the code rate and the modulation scheme in which a block error rate (BLER) is 0.1 or less when the SNR is represented by the following expression.

\tilde{γ}_{j′} [Expression 13]

However, the CQI #0 is selected if the CQI #1 has the BLER that is greater than 0.1.

Here, the precoding matrix Up, has been applied to the CSI-RS that is transmitted from the base station 100. Thus, when the channel estimation is ideally performed, a channel H_{A} that is estimated by the CSI-RS channel estimation section 206 is represented as follows:

H_{A}=H₀U_{A}=(h₁h₂exp(jφ_{A})) [Expression 14]

The CSI measurement section 208 determines CSI #A to be reported to the base station 100 based on the estimated channel. As described above, the CSI measurement section 208 selects the precoding vector that maximizes the SNR of the terminal 200 itself from the codebook to determine the PMI and sets the value resulting from quantization of the above SNR as the CQI (SQ1002).

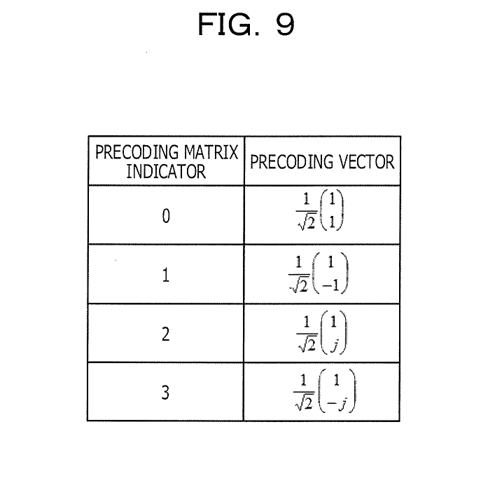

FIG. 9 illustrates an example of the codebook. The codebook in FIG. 9 is an example of the codebook of LTE in a case where the base station 100 has two antennas. The codebook in FIG. 9 defines precoding vectors whose phase differences between antenna elements are 90 degrees.

The CSI reporting section 210 transmits the CSI (CSI #A) that includes the PMI and CQI that are determined by the CSI measurement section 208 to the base station 100 (SQ1003). The CSI is an example of channel state information.

A precoding vector v_{A} that corresponds to the PMI that the terminal 200 reports to the base station 100 is the vector that is represented by the following expression.

v_{A}≈H_{A}^{H} [Expression 15]

The CSI reception section 110 of the base station 100 receives the CSI #A from the terminal 200.

The channel estimation section 126 performs the downlink channel estimation based on the CSI from the terminal 200. Here, the CSI from the terminal 200 has a value that is determined based on the channel changed by the precoding matrix U_{A} applied to the CSI-RS. Accordingly, the channel estimation section 126 performs the channel estimation by the following expression while taking into account the precoding matrix U_{A} at transmission of the CSI-RS (SQ1004).

Ĥ_{A}=v_{A}^{H}U_{A}⁻¹ [Expression 16]

Here, the precoding matrix U_{A} is given from the precoding switching process section 122 to the channel estimation section 126. Expression 16 represents the channel that is estimated based on a CSI report for the CSI-RS that is transmitted with the precoding matrix U_{A}.

The precoding switching process section 122 of the base station 100 further determines the precoding matrix to be applied to the CSI-RS in a predetermined second period. Here, the precoding switching process section 122 determines the precoding matrix U_{B} that is represented by the following expression as the precoding matrix to be applied to the CSI-RS. The precoding switching process section 122 notifies the CSI-RS precoding process section 124 of the determined precoding matrix U_{B}.

$${U}_{B} = ( \begin{matrix}1 & 0 \\ 0 & exp ( j {φ}_{B} )\end{matrix} ) \qquad [ Expression 17 ]$$

Here, φ_{B} is a different value from φ_{A}.

The CSI-RS generation section 114 generates the CSI-RS to be transmitted to the terminal 200. The CSI-RS is common to all the terminals and is used for the CSI measurement at each of the terminals. The CSI-RS generation section 114 transmits the generated CSI-RS to the CSI-RS precoding process section 124.

The CSI-RS precoding process section 124 applies the precoding matrix U_{B} that is determined by the precoding switching process section 122 to the CSI-RS that is generated by the CSI-RS generation section 114. The CSI-RS precoding process section 124 transmits the CSI-RS with the applied precoding matrix U_{B} to the signal transmission section 108.

The signal transmission section 108 transmits the CSI-RS with the precoding matrix U_{B} applied in the predetermined second period to the terminal 200 (SQ1005). The second period is a period that is later than the first period.

The CSI-RS channel estimation section 206 of the terminal 200 receives the CSI-RS with the applied precoding matrix U_{g} from the base station 100. The CSI-RS channel estimation section 206 performs the channel estimation based on the received signal. At that time, because the precoding matrix U_{B} is applied to the CSI-RS, when the channel estimation is ideally performed, a channel H_{B} that is estimated by the CSI-RS channel estimation section 206 is represented as follows:

H_{B}=H₀U_{B}=(h₁h₂exp(jφ_{B})) [Expression 18]

The CSI measurement section 208 determines CSI #B to be reported to the base station 100 based on the estimated channel. The CSI measurement section 208 selects the precoding vector that maximizes the SNR of the terminal 200 itself from the codebook as illustrated in FIG. 9 to determine the PMI and sets the value resulting from quantization of the above SNR as the CQI (SQ1006).

The CSI reporting section 210 transmits the CSI (CSI #B) that includes the PMI and CQI that are determined by the CSI measurement section 208 to the base station 100 (SQ1007).

A precoding vector v_{B} that corresponds to the PMI that the terminal 200 reports to the base station 100 is the vector that is represented by the following expression.

v_{B}≈H_{B}^{H} [Expression 19]

The CSI reception section 110 of the base station 100 receives the CSI #B from the terminal 200 (SQ1007).

The channel estimation section 126 performs the downlink channel estimation based on the CSI from the terminal 200. Here, the CSI from the terminal 200 has a value that is determined based on the channel changed by the precoding matrix U_{B} applied to the CSI-RS. Accordingly, the channel estimation section 126 performs the channel estimation by the following expression while taking into account the precoding matrix U_{B} at the transmission of the CSI-RS (SQ1008).

Ĥ_{B}=v_{B}^{H}U_{B}⁻¹ [Expression 20]

Here, the precoding matrix U_{B} is given from the precoding switching process section 122. The left side of Expression 20 represents the channel that is estimated based on a CSI report for the CSI-RS that is transmitted with the precoding matrix U_{B}.

Further, after the downlink channel estimation is finished with the two precoding matrices (U_{A} and U_{B}), the channel estimation section 126 calculates a downlink channel to be used for transmission of the data signal, for example, as follows (SQ1009):

$${\hat{H}}_{0} = \frac{{{α}_{A} ( {β}_{A} )}^{p} {\hat{H}}_{A} + {{α}_{B} ( {β}_{B} )}^{p} {\hat{H}}_{B}}{{{α}_{A} ( {β}_{A} )}^{p} + {{α}_{B} ( {β}_{B} )}^{p}} \qquad [ Expression 21 ]$$

Here, α_{A} and β_{A} are weights related to the CSI #A (precoding matrix U_{A}), and α_{B} and β_{B} are weights related to the CSI #B (precoding matrix U_{B}). p is a weight that is common to the CSI #A (precoding matrix U_{A}) and the CSI #B (precoding matrix U_{B}). α_{A} and α_{B} (weight a) are set as values that depend on the CQI. That is, α_{A} and α_{B} are set as greater values when the CQI is greater. For example, α_{A} and α_{B} are set as values that are directly proportional to the CQI. β_{A} and β_{B} (weight β) are values that depend on time of the report of the CSI. That is, β_{A} and β_{B} are set as greater values when the time of the report of the CSI is later. For example, β_{A} and β_{B} are set as values that are inversely proportional to the difference between present time and the time of the report of the CSI (the proportionality constant is set as a positive value). p (weight p) is a value that depends on channel fluctuation in the time direction. That is, p is set as a greater value when the channel fluctuation in the time direction is larger. For example, p is set as a value that is proportional to the absolute value of the moving speed of the terminal 200. p is set as a value that is zero or greater.

When the channel fluctuation in the time direction is large, a channel state based on a more recently reported CSI is considered to have less difference from a present channel state. Thus, p is set as a greater value when the channel fluctuation is larger.

Further, at least one of the weights α, β, and p may be fixed to 1. For example, in a case where the channel state is stable in the time axis direction, all of the weights α, β, and p may be set to 1.

Although the precoding matrices U_{A} and U_{B} are precoding matrices to perform phase rotation, the precoding matrices may be those to change an amplitude or change a phase and the amplitude. Further, the precoding matrices may have a value that is not zero as a component other than diagonal components.

The codebook in FIG. 9 defines the precoding vectors whose phase differences between the antenna elements are 90 degrees. Thus, when the phase difference between the antennas that is actually desired by the terminal 200 is reported as the PMI, a maximum error of 45 degrees (error due to quantization) may occur. Accordingly, based on the maximum value of the error due to quantization, phase rotation amounts with respect to a second antenna element of the precoding matrices U_{A} and U_{B} are set to φA=0 and φB=π/4. Here, two kinds of precoding matrices are used. However, three or more kinds of precoding matrices may be used. For example, the phase rotation amount of an i-th precoding matrix with respect to an i-th antenna element in a case where n kinds of precoding matrices are used is given by (i−1)π/2n[rad], for example.

Communication resources included in each of the periods are an example of a communication resource group. For example, the communication resources included in the first period are an example of a first communication resource group, and the communication resources included in the second period are an example of a second communication resource group.

An order of respective sequences described here may be changed, if possible.

### Modification Example 1

Here, a description is made about a modification example 1 of the operation example 1 between the base station 100 and the terminal 200. The modification example 1 has features in common with the operation example 1. Here, a description is mainly made about different features between the modification example 1 and the operation example 1.

In the above procedure, when the CSI (CSI #A or CSI #B) that the terminal 200 reports to the base station 100 is determined, an accurate channel estimation is difficult if the channel estimation is not performed by using the CSI-RS that is transmitted with the same precoding matrix. For example, in a case where the terminal 200 performs the channel estimation based on the average value of the CSI-RS transmitted with the precoding #A and the CSI-RS transmitted with the precoding #B, the terminal 200 estimates a channel that is synthesized of the channels H_{A} and H_{B}. Thus, it is difficult for the base station 100 to correctly estimate the channel. Accordingly, the base station 100 switches the precoding matrices for each of the periods in which it is ensured that the terminal 200 performs the CSI measurement by using the CSI-RS within a specified period. In LTE-A, for example, a specification called CSI resource measurement restriction that is provided by 3GPP Release 10 may be used. In this specification, subframes are categorized into two kinds of subframe groups that are called subframe subsets (subframe subset #1 and subframe subset #2). Here, the subframe is formed by splitting a frame in a length of 10 ms into 10 parts, and a length of one subframe is 1 ms. The terminal 200 in which the CSI resource measurement restriction is set calculates the CSI for the periods of the subframe subset #1 and the subframe subset #2 based on the CSI-RSs that are transmitted in the respective periods.

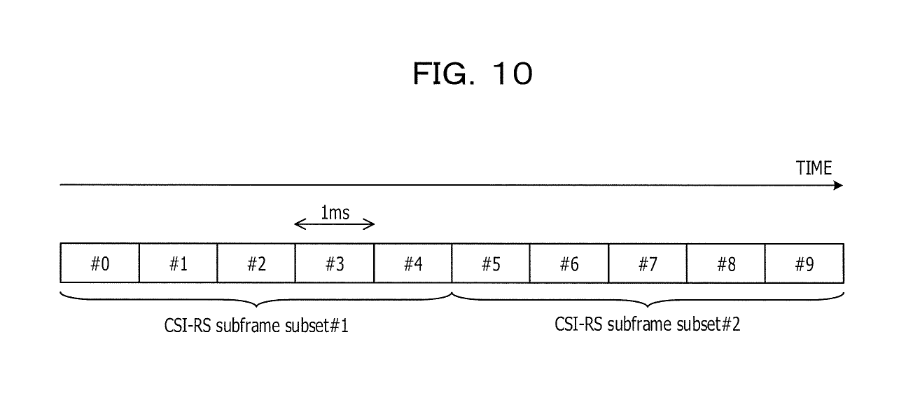

FIG. 10 illustrates an example of the subframe subset. In the example of FIG. 10, subframes #0 to #4 constitute the subframe subset #1, and subframes #5 to #9 constitute the subframe subset #2.

When the subframe subsets are set as illustrated in FIG. 10, the base station 100 transmits the CSI-RS with the precoding #A for the subframes #0 to #4 and transmits the CSI-RS with the precoding #B for the subframe #5 to #9. This enables one-to-one correspondence between the precoding in transmission of the CSI-RS and the CSI that is fed back from the terminal.

### Operation and Effect of the First Embodiment

The base station 100 applies the precoding matrix to the CSI-RS and transmits the CSI-RS to the terminal 200. The base station 100 applies the precoding matrix U_{A} to the CSI-RS in the predetermined first period and transmits the CSI-RS to the terminal 200. The base station 100 applies the precoding matrix U_{B} to the CSI-RS in the predetermined second period and transmits the CSI-RS to the terminal 200. The base station 100 temporally switches the precoding matrices to be applied to the CSI-RS, transmits the CSI-RS, and thereby enables fluctuation of the channel state at the determination of the CSI by the terminal 200 without demanding a special operation from the terminal 200. Accordingly, the downlink channel estimation may be performed based on channel estimation results for different precoding matrices, thereby allowing an improvement in the accuracy of the channel estimation.

The base station 100 may contribute to the improvement in the accuracy of the channel estimation by applying the temporally-different precoding matrices to the CSI-RS without increasing the size of the codebook.

### Second Embodiment

Next, a second embodiment is described. The second embodiment has features in common with the first embodiment. Thus, a description is mainly made about different features, and a description about the common features is not made.

Here, a description is made about an example where, in LTE-A, the base station that includes two antennas transmits the CSI-RS with two kinds of precodings (precodings #A and #B) and the channel estimation is performed by using the CSI fed back from the terminal that includes one antenna. Here, the base station applies different precodings to the CSI-RS based on frequencies. Further, the channel estimation is performed based on the CSI that is fed back from the terminal while taking into account the precoding matrix applied to the CSI-RS. The CSI includes the CQI that indicates a channel quality and the PMI that represents the precoding vector desired by the terminal.

### Configuration Example 2

A configuration of this embodiment is similar to the configuration of the first embodiment. Accordingly, a description is made with the base station 100 and the terminal 200 of the first embodiment in an operation example 2 described below.

### Operation Example 2

Here, a description is made about the operation example 2 between the base station 100 and the terminal 200. In the operation example 2, the base station 100 switches the precoding matrices to be applied to the CSI-RS in the frequency direction (frequency axis direction).

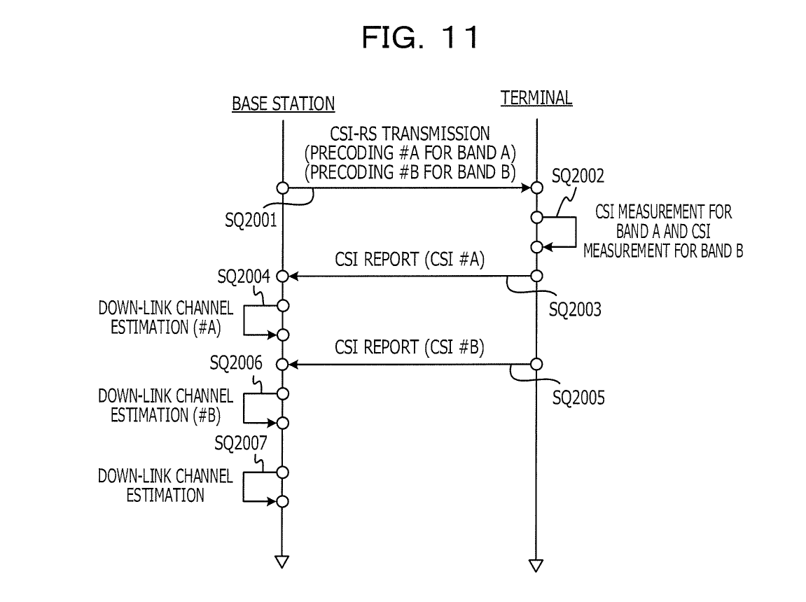

FIG. 11 illustrates an example of an operation sequence between the base station 100 and the terminal 200.

The precoding switching process section 122 of the base station 100 determines the precoding matrix to be applied to the CSI-RS. Here, the precoding switching process section 122 determines the precoding matrix U_{A} and U_{B} of the first embodiment as the precoding matrices (referred to as precoding matrices U′_{A} and U′_{B}) to be applied to the CSI-RS. The precoding matrix U′_{A} is applied to a CSI-RS of one band (referred to as band A) resulting from splitting of the whole band between the base station 100 and the terminal 200 into two bands. The precoding matrix U′_{B} is applied to a CSI-RS of the other band (referred to as band B) resulting from splitting of the whole band between the base station 100 and the terminal 200 into two bands. The precoding switching process section 122 notifies the CSI-RS precoding process section 124 of the determined precoding matrices U′_{A} and U′_{B}.

The CSI-RS generation section 114 generates the CSI-RS to be transmitted to the terminal 200. The CSI-RS is common to all the terminals and is used for the CSI measurement at each of the terminals. The CSI-RS generation section 114 transmits the generated CSI-RS to the CSI-RS precoding process section 124.

The CSI-RS precoding process section 124 applies the precoding matrix U′_{A} that is determined by the precoding switching process section 122 to the CSI-RS for the band A. The CSI-RS precoding process section 124 applies the precoding matrix U′_{B} that is determined by the precoding switching process section 122 to the CSI-RS for the band B. The CSI-RS precoding process section 124 transmits the CSI-RS for the band A with the applied precoding matrix U′_{A} and the CSI-RS for the band B with the applied precoding matrix U′_{B} to the signal transmission section 108.

The signal transmission section 108 transmits the CSI-RS for the band A with the applied precoding matrix U′_{A} and the CSI-RS for the band B with the applied precoding matrix U′_{B} to the terminal 200 (SQ2001). The CSI-RS channel estimation section 206 of the terminal 200 receives the CSI-RS for the band A with the applied precoding matrix U′_{A} and the CSI-RS for the band B with the applied precoding matrix U′_{B} from the base station 100.

The CSI-RS channel estimation section 206 performs the channel estimation based on the received signal for each of the bands (SQ2002).

The CSI measurement section 208 determines CSI #A to be reported to the base station 100 based on the estimated channel for the band A. The CSI measurement section 208 selects the precoding vector that maximizes the SNR of the terminal 200 itself from the codebook with respect to the band A to determine the PMI and sets the value resulting from quantization of the above SNR as the CQI.

Similarly, the CSI measurement section 208 determines CSI #B to be reported to the base station 100 based on the estimated channel for the band B. The CSI measurement section 208 selects the precoding vector that maximizes the SNR of the terminal 200 itself from the codebook with respect to the band B to determine the PMI and sets the value resulting from quantization of the above SNR as the CQI.

The CSI reporting section 210 transmits the CSI (CSI #A) that includes the PMI and CQI that are determined by the CSI measurement section 208 to the base station 100 (SQ2003).

The CSI reception section 110 of the base station 100 receives the CSI #A from the terminal 200. The channel estimation section 126 performs the downlink channel estimation for the band A based on the CSI #A from the terminal 200. Here, the CSI #A from the terminal 200 has a value that is determined based on the channel changed by the precoding matrix U′_{A} applied to the CSI-RS. Accordingly, the channel estimation section 126 performs the channel estimation for the band A in a similar manner to the first embodiment while taking into account the precoding matrix U′_{A} at transmission of the CSI-RS (SQ2004). The channel state of the band A is estimated as represented by the following expression.

Ĥ′_{A}=v′_{A}^{H}U′_{A}⁻¹ [Expression 22]

Here, v′_{A} is the precoding vector that is represented by the PMI included in the CSI #A fed back from the terminal 200.

Meanwhile, the CSI reporting section 210 of the terminal 200 transmits the CSI (CSI #B) that includes the PMI and CQI that are determined by the CSI measurement section 208 to the base station 100 (SQ2005).

The CSI reception section 110 of the base station 100 receives the CSI #B from the terminal 200. The channel estimation section 126 performs the downlink channel estimation for the band B based on the CSI #B from the terminal 200. Here, the CSI #B from the terminal 200 has a value that is determined based on the channel changed by the precoding matrix U′_{B}; applied to the CSI-RS. Accordingly, the channel estimation section 126 performs the channel estimation for the band B as represented by the following expression in a similar manner to the first embodiment while taking into account the precoding matrix U_{B} at transmission of the CSI-RS (SQ2006). The channel state of the band B is estimated as represented by the following expression.

Ĥ′_{B}=v′_{B}^{H}U′_{B}⁻¹ [Expression 23]

Here, v′_{B} is the precoding vector that is represented by the PMI included in the CSI #B fed back from the terminal 200.

Further, after the downlink channel estimation is finished with the two precoding matrices (U′_{A} and U′_{B}), the channel estimation section 126 calculates a downlink channel for the band A, for example, as follows (SQ2007):

$${\hat{H}}_{A , 0}^{′} = \frac{{{α}_{A}^{′} ( {γ}_{0} )}^{q} {\hat{H}}_{A}^{′} + {{α}_{B}^{′} ( {γ}_{1} )}^{q} {\hat{H}}_{B}^{′}}{{{α}_{A}^{′} ( {γ}_{0} )}^{q} + {{α}_{B}^{′} ( {γ}_{1} )}^{q}} \qquad [ Expression 24 ]$$

Here, γ₀ and γ₁ (weight γ) are weights related to the frequency difference between a band to be obtained (here, the band A) and a channel estimation result that serves as a reference and are values that satisfy γ₀>γ₁≧0, for example. α′_{A} is a weight related to the CSI #A (precoding matrix U′_{A}). α′_{B} is a weight related to the CSI #B (precoding matrix U′_{B}). q is a weight that is common to the CSI #A (precoding matrix U′_{A}) and the CSI #B (precoding matrix U′_{B}). α′_{A} and α′_{B} (weight α′) are set as values that depend on the CQI. That is, α′_{A} and α′_{B} are set as greater values when the CQI is greater. For example, α′_{A} and α′_{B} are set as values that are directly proportional to the CQI. Further, taking into account fluctuation in the frequency direction, the channel estimation result for the band A is preferentially weighted by the weights γ₀ and γ₁. q (weight q) is set as a value that depends on channel fluctuation in the frequency direction. That is, q is set as a greater value when the channel fluctuation in the frequency direction is larger. q is set as a value that is zero or greater.

The channel estimation section 126 calculates a downlink channel for the band B in a similar manner as follows:

$${\hat{H}}_{B , 0}^{′} = \frac{{{α}_{A}^{′} ( {γ}_{1} )}^{q} {\hat{H}}_{A}^{′} + {{α}_{B}^{′} ( {γ}_{0} )}^{q} {\hat{H}}_{B}^{′}}{{{α}_{A}^{′} ( {γ}_{1} )}^{q} + {{α}_{B}^{′} ( {γ}_{0} )}^{q}} \qquad [ Expression 25 ]$$

At least one of the weights α′, γ, and q may be fixed to 1. For example, in a case where the channel state is stable in the frequency axis direction, all of the weights α′, γ, and q may be set to 1.

An order of respective sequences that is described here may be changed, if possible. For example, after the CSI reports of sequences SQ2003 and SQ2005, the downlink channel estimations of sequences SQ2004 and SQ2006 may be performed.

Communication resources included in each of the bands are an example of a communication resource group. For example, the communication resources included in the band A are an example of a first communication resource group, and the communication resources included in the band B are an example of a second communication resource group.

### Operation and Effect of the Second Embodiment

The base station 100 precodes the CSI-RS with the different precoding matrix for each of the frequency bands and transmits the CSI-RS to the terminal 200. The terminal 200 performs the CSI report for each of the bands. The base station 100 performs the channel estimation based on the CSI report and the precoding matrix for each of the bands. The base station 100 performs the channel estimation for the whole system band, based on the channel estimation for each of the bands.

The base station 100 transmits the CSI-RS with the different precoding matrix for each of the bands and may thereby increase the channel estimation accuracy of a single channel estimation result.

The base station 100 may contribute to the improvement in the accuracy of the channel estimation by applying the different precoding matrix to the CSI-RS for each of the bands without increasing the size of the codebook.

### Third Embodiment

Next, a third embodiment is described. The third embodiment has features in common with the first and second embodiments. Thus, a description is mainly made about different features, and a description about the common features is not made.

In the first embodiment, the precoding matrices are switched according to the time. In the second embodiment, the precoding matrices are switched according to the communication bands. In the third embodiment, the precoding matrices are switched in accordance with the time and the communication bands. In the configuration of the first or second embodiment, the terminal has a function to estimate the channel state by using the communication resource group that is associated with the same precoding matrix, and the base station may thereby flexibly determine the communication resource group for switching the precoding matrices. In this case, it is desired that the terminal somehow recognize the communication resource group for which the base station switches the precoding matrices. This may be enabled by introducing a signal for notifying the terminal of a timing when the precoding matrices are switched in the specification of LTE-A, for example. Here, a description is made about a configuration where the terminal is in advance notified of the timing when the base station switches the precoding matrices and the terminal performs the channel estimation based on that timing.

### Configuration Example 3

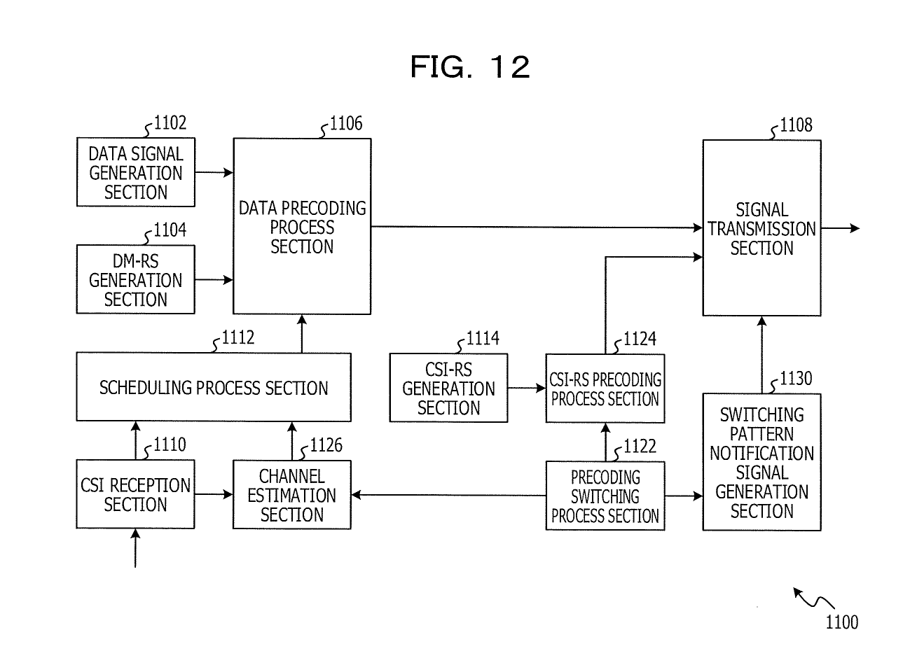

FIG. 12 illustrates an example of function blocks of the base station according to this embodiment. The base station 1100 includes a data signal generation section 1102, a DM-RS generation section 1104, a data precoding process section 1106, a signal transmission section 1108, a CSI reception section 1110, a scheduling process section 1112, and a CSI-RS generation section 1114. Further, the base station 1100 includes a precoding switching process section 1122, a CSI-RS precoding generation section 1124, and a channel estimation section 1126. In addition, the base station 1100 includes a switching pattern notification signal generation section 1130.

The precoding switching process section 1122 switches precoding matrices that are used by the CSI-RS precoding process section 1124. The precoding switching process section 1122 determines the precoding matrix for each communication resource group by which the CSI-RS is transmitted and notifies the CSI-RS precoding process section 1124 of the determined precoding matrices. The precoding switching process section 1122 provides the channel estimation section 1126 and the switching pattern notification signal generation section 1130 with information about the precoding matrix at transmission of the CSI-RS.

The switching pattern notification signal generation section 1130 notifies a terminal 1200 of the communication resource group for which the precoding switching process section 1122 switches the precoding matrices via the signal transmission section 1108.

The other function blocks of the base station 1100 have similar functions to the corresponding function blocks of the base station 100 of the first embodiment.

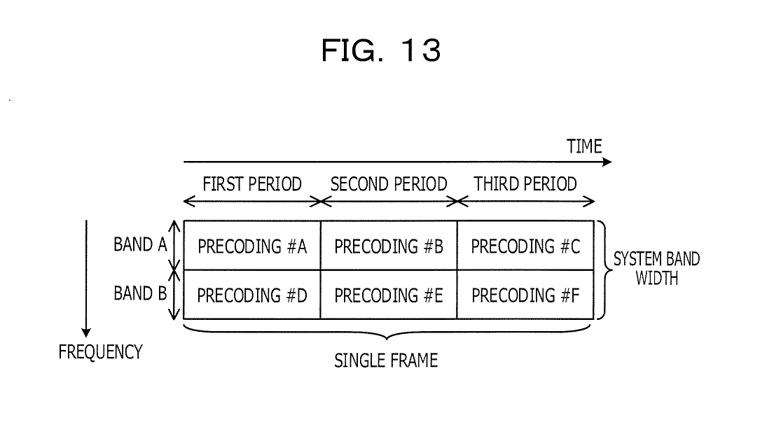

FIG. 13 illustrates an example of the communication resource groups and the precoding matrices. The communication resources in a single frame of FIG. 13 are split into three parts in the time direction and into two parts in the frequency direction in the single frame. Here, the communication resources in the single frame are split into six communication resource groups. Further, in FIG. 13, a precoding matrix is allocated to each of the communication resource groups.

The communication resource groups that are used for switching the precodings may desirably be set and may be set in consideration of the density of the CSI-RS that is transmitted by the base station 1100 and the overhead that is used for the CSI report by the terminal 1200, for example.

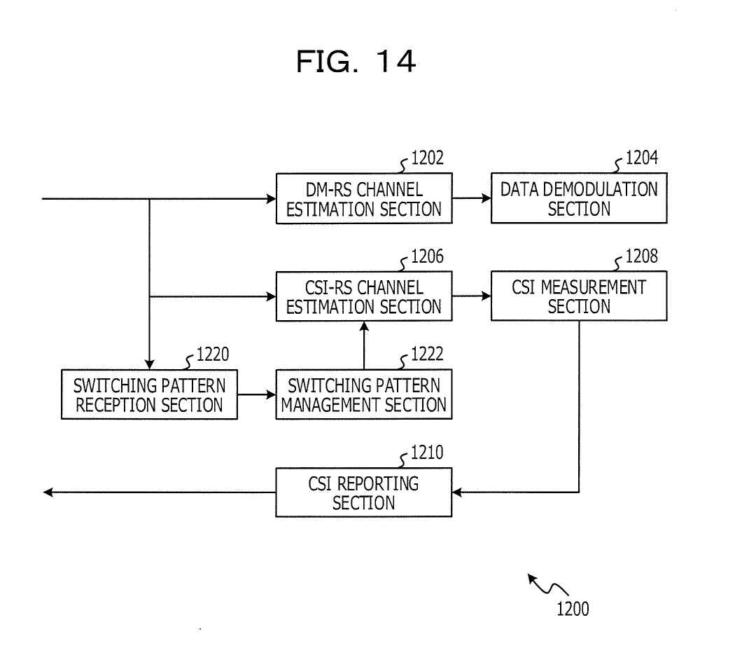

FIG. 14 illustrates an example of function blocks of the terminal according to this embodiment. The terminal 1200 in FIG. 14 includes a DM-RS channel estimation section 1202, a data demodulation section 1204, a CSI-RS channel estimation section 1206, a CSI measurement section 1208, and a CSI reporting section 1210. In addition, the terminal 1200 includes a switching pattern reception section 1220 and a switching pattern management section 1222.

The switching pattern reception section 1220 receives from the base station 1100 information about the communication resource group for which the precoding matrices are switched.

The switching pattern management section 1222 performs control so that the channel estimation by the CSI-RS channel estimation section 1206 is performed for the communication resource group that is associated with the same precoding based on the information that is received by the switching pattern reception section 1220. The switching pattern management section 1222 keeps the information about the communication resource group for which the precoding matrices are switched.

The other function blocks of the base station 1200 have similar functions to the corresponding function blocks of the base station 200 in the first embodiment.

### Operation example 3

Here, a description is made about the operation example 3 between the base station 1100 and the terminal 1200. In the operation example 3, the base station 1100 switches the precoding matrices to be applied to the CSI-RS in the frequency direction and the time direction.

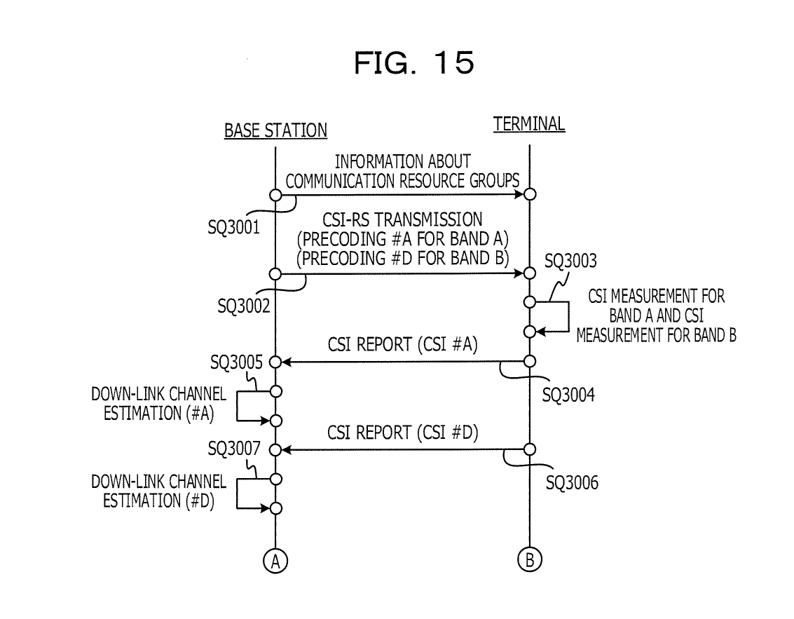

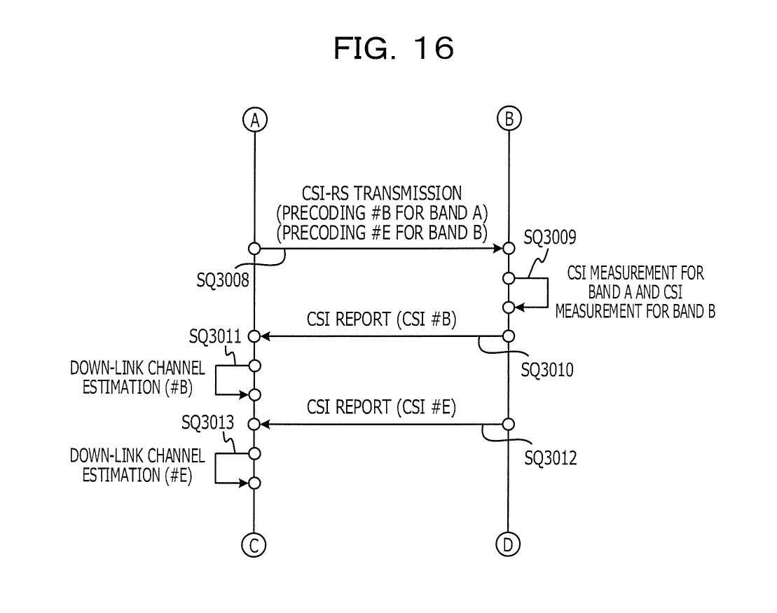

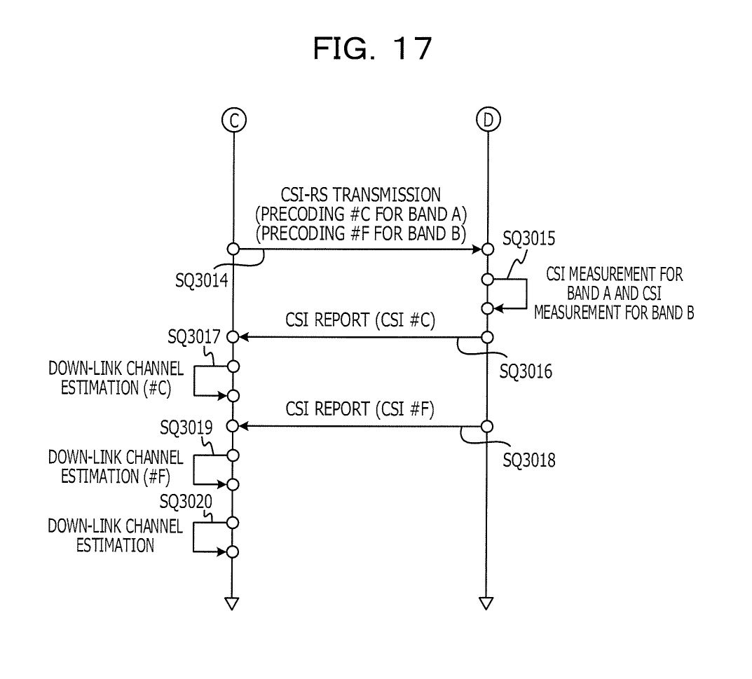

FIGS. 15, 16, and 17 illustrate an example of an operation sequence between the base station 1100 and the terminal 1200. The symbols “A” and “B” in FIG. 15 are respectively connected to the symbols “A” and “B” in FIG. 16. The symbols “C” and “D” in FIG. 16 are respectively connected to the symbols “C” and “D” in FIG. 17.

The precoding switching process section 1122 of the base station 1100 determines the precoding matrix to be applied to the CSI-RS for each of the communication resource groups. Here, as illustrated in FIG. 13, the single frame is split into the six communication resource groups. Here, the single frame is split into two parts in the frequency direction and into three parts in the time direction. However, the number of splits is not limited to this but may desirably be determined. Here, as illustrated in FIG. 13, the precoding switching process section 1122 determines precodings #A to #F as the precoding matrices to be applied to the CSI-RSs for the respective communication resource groups. For example, the precoding #A is applied to the CSI-RS in a first period for one band that is resulting from splitting of the whole band between the base station 1100 and the terminal 1200 into two bands and is referred to as band A. The precoding switching process section 1122 notifies the CSI-RS precoding process section 1124 of the determined precoding matrix.

Further, the precoding switching process section 1122 notifies the switching pattern notification signal generation section 1130 of information about the communication resource groups. The information about the communication resource groups is the number of splits in the frequency direction and the number of splits in the time direction in the single frame, for example. The information about the communication resource groups identifies which communication resource belongs to which communication resource group. At least the communication period and frequency band in which communication is performed are allocated to each of the communication resource groups. Identification information may be added to each of the communication resource group.

The switching pattern notification signal generation section 1130 transmits the information about the communication resource groups that is received from the precoding switching process section 1122 to the signal transmission section 1108.

The signal transmission section 1108 transmits the information about the communication resource groups to the terminal 1200 (SQ3001). The information about the communication resource group may be transmitted as a data signal or a control signal. The switching pattern reception section 1220 of the terminal 1200 receives the information about the communication resource groups from the base station 1100. The switching pattern reception section 1220 transmits the received information about the communication resource groups to the switching pattern management section 1222. Identification information that identifies each of the communication resource groups may be included in the information of the communication resource group.

Meanwhile, the CSI-RS generation section 1114 of the base station 1100 generates the CSI-RS to be transmitted to the terminal 1200. The CSI-RS is common to all the terminals and is used for the CSI measurement at each of the terminals. The CSI-RS generation section 1114 transmits the generated CSI-RS to the CSI-RS precoding process section 1124.

The CSI-RS precoding process section 1124 applies the precoding #A that is determined by the precoding switching process section 1122 to the CSI-RS for the band A in the first period. The CSI-RS precoding process section 1124 applies the precoding #D that is determined by the precoding switching process section 1122 to the CSI-RS for the band B in the first period. The CSI-RS precoding process section 1124 transmits the CSI-RS for the band A in the first period with the applied precoding #A and the CSI-RS for the band B in the first period with the applied precoding #D to the signal transmission section 1108.

The signal transmission section 1108 transmits the CSI-RS for the band A in the first period with the applied precoding #A and the CSI-RS for the band B in the first period with the applied precoding #D to the terminal 1200 (SQ3002).

The CSI-RS channel estimation section 1206 of the terminal 1200 receives the CSI-RS for the band A in the first period with the applied precoding #A and the CSI-RS for the band B in the first period with the applied precoding #D from the base station 1100. Further, the CSI-RS channel estimation section 1206 receives the information about the communication resource groups from the switching pattern management section 1222. The CSI-RS channel estimation section 1206 performs the channel estimation for each of the communication resource groups (for the band A in the first period and for the band B in the first period) based on the received signal (SQ3003).

The CSI measurement section 1208 determines CSI #A to be reported to the base station 1100 based on the estimated channel for the band A in the first period. The CSI measurement section 1208 selects the precoding vector that maximizes the SNR of the terminal 1200 itself from the codebook with respect to the band A in the first period to determine the PMI and sets the value resulting from quantization of the above SNR as the CQI.

Similarly, the CSI measurement section 1208 determines CSI #D to be reported to the base station 1100 based on the estimated channel for the band B in the first period. The CSI measurement section 1208 selects the precoding vector that maximizes the SNR of the terminal 1200 itself from the codebook with respect to the band B in the first period to determine the PMI and sets the value resulting from quantization of the above SNR as the CQI.

The CSI reporting section 1210 transmits the CSI (CSI #A) that includes the PMI and CQI that are determined by the CSI measurement section 1208 to the base station 1100 (SQ3004). Identification information that identifies the communication resource groups that are used for the channel estimation may be included in the CSI #A.

The CSI reception section 1110 of the base station 1100 receives the CSI #A from the terminal 1200. The channel estimation section 1126 performs the downlink channel estimation for the band A in the first period based on the CSI #A from the terminal 1200. Here, the CSI #A from the terminal 1200 has a value that is determined based on the channel changed by the precoding #A applied to the CSI-RS. Accordingly, the channel estimation section 1126 performs the channel estimation for the band A in the first period in a similar manner to the first embodiment while taking into account the precoding #A at the transmission of the CSI-RS (SQ3005).

Meanwhile, the CSI reporting section 1210 transmits the CSI (CSI #D) that includes the PMI and CQI that are determined by the CSI measurement section 1208 to the base station 1100 (SQ3006). Identification information that identifies the communication resource group that are used for the channel estimation may be included in the CSI #D.

The CSI reception section 1110 of the base station 1100 receives the CSI #D from the terminal 1200. The channel estimation section 1126 performs the downlink channel estimation for the band B in the first period based on the CSI #D from the terminal 1200. Here, the CSI #D from the terminal 1200 has a value that is determined based on the channel changed by the precoding #D applied to the CSI-RS. Accordingly, the channel estimation section 1126 performs the channel estimation for the band B in the first period in a similar manner to the first embodiment while taking into account the precoding #D at the transmission of the CSI-RS (SQ3007).

The signal transmission section 1108 transmits the CSI-RS for the band A in the second period with the applied precoding #B and the CSI-RS for the band B in the second period with the applied precoding #E to the terminal 1200 (SQ3008).

The operations of sequences SQ3009 to SQ3013 in the second period are similar to the operations from sequences SQ3003 to SQ3007 in the first period.

The signal transmission section 1108 transmits the CSI-RS for the band A in the third period with the applied precoding #C and the CSI-RS for the band B in the third period with the applied precoding #F to the terminal 1200 (SQ3014).

The operations of sequences SQ3015 to SQ3019 in the third period are similar to the operations from sequences SQ3003 to SQ3007 in the first period.

Further, after the downlink channel estimation is finished with the six precoding matrices (#A through #F), the channel estimation section 1126 calculates downlink channels for the bands A and B by combining methods of the channel estimation in the operation examples 1 and 2 (SQ3020). That is, the channel estimation is performed in the time direction in a similar manner to the operation example 1, the channel estimation is then performed in the frequency direction in a similar manner to the operation example 2, and the downlink channels for the bands A and B are thereby calculated.

An order of respective sequences that is described here may be changed, if possible. For example, after the CSI-RS transmission of sequences SQ3002, SQ3008, and SQ3014, the CSI measurement of sequences SQ3003, SQ3009, and SQ3015 may be performed.

### Operation and Effect of the Third Embodiment

The base station 1100 changes the precodings that the base station 1100 applies to the CSI-RS in the time direction and the frequency direction. At that time, the base station 1100 notifies the terminal 1200 of the information about the communication resource groups for which the precodings are switched. The terminal 1200 determines the CSI for each of the communication resource groups according to that information and reports the CSI for each of the communication resources to the base station 1100.

Accordingly, the base station 1100 may perform the channel estimation by switching the total of six kinds of precodings in the single frame, for example. Therefore, the base station 1100 may improve the channel estimation accuracy even when the channel fluctuation is large, for example.

The foregoing embodiments may be carried out while combining the embodiments, if possible.

Embodiments of the present disclosure may be implemented by execution of a program by an information processing apparatus. That is, a configuration of the present disclosure may specify the processes that are executed by each unit or section in the above-described embodiments as a program to be executed by the information processing apparatus or a computer-readable recording medium that records the program. Further, a configuration of the present disclosure may be specified by a method with which the information processing apparatus executes the processes to be executed by each of the units and sections. A configuration of the present disclosure may be specified as a system that includes the information apparatus that performs the processes to be executed by each of the units and sections.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A radio base station comprising:
a memory; and
a processor coupled to the memory and configured to
precode a first reference signal based on a first precoding matrix and a second reference signal based on a second precoding matrix,
transmit the precoded first reference signal using a first radio resource and the precoded second reference signal using a second radio resource, to a radio terminal,
receive first channel state information and second channel state information from the radio terminal, the first channel state information indicating a first channel estimated at the radio terminal based on the precoded first reference signal, the second channel state information indicating a second channel estimated at the radio terminal based on the precoded second reference signal, and
estimate a downlink channel between the radio base station and the radio terminal based on the first channel state information, the second channel state information, the first precoding matrix, and the second precoding matrix.

2. The radio base station according to claim 1, wherein
the first radio resource and the second radio resource don't overlap in time direction.

3. The radio base station according to claim 2, wherein
for estimating the downlink channel, the processor is configured to
calculate the first channel based on the first channel state information and the first precoding matrix,
calculate the second channel based on the second channel state information and the second precoding matrix, and
estimate the downlink channel based on the calculated first channel and the calculated second channel.

4. The radio base station according to claim 3, wherein
the downlink channel is estimated to be a weighted average of the calculated first channel and the calculated second channel.

5. The radio base station according to claim 4, wherein
the first resource is prior to the second resource in time direction, and
a weight of the calculated first channel is not more than a weight of the calculated second channel.

6. The radio base station according to claim 1, wherein
the first radio resource and the second radio resource don't overlap in frequency direction.

7. The radio base station according to claim 6, wherein
for estimating the downlink channel, the processor is configured to
calculate the first channel based on the first channel state information and the first precoding matrix,
calculate the second channel based on the second channel state information and the second precoding matrix, and
estimate the downlink channel based on the calculated first channel and the calculated second channel.

8. The radio base station according to claim 7, wherein
the downlink channel includes a first downlink channel corresponding to the first radio resource and a second downlink channel corresponding to the second radio resource, and
the first downlink channel and the second downlink channel are estimated to be a weighted averages of the calculated first channel and the calculated second channel.

9. The radio base station according to claim 8, wherein
for the first downlink channel, a weight of the calculated first channel is more than a weight of the calculated second channel, and
for the second downlink channel, a weight of the calculated first channel is less than a weight of the calculated second channel.

10. The radio base station according to claim 1, wherein
the processor is configured to transmit information indicating the first radio resource and the second radio resource.

11. A channel estimation method comprising:
precoding a first reference signal based on a first precoding matrix and a second reference signal based on a second precoding matrix;
transmitting the precoded first reference signal using a first radio resource and the precoded second reference signal using a second radio resource, to a radio terminal;
receiving first channel state information and second channel state information from the radio terminal, the first channel state information indicating a first channel estimated at the radio terminal based on the precoded first reference signal, the second channel state information indicating a second channel estimated at the radio terminal based on the precoded second reference signal; and
estimating a downlink channel between the radio base station and the radio terminal based on the first channel state information, the second channel state information, the first precoding matrix, and the second precoding matrix.

12. The channel estimation method according to claim 11, wherein
the first radio resource and the second radio resource don't overlap in time direction.

13. The channel estimation method according to claim 12, wherein
the estimating the downlink channel includes
calculating the first channel based on the first channel state information and the first precoding matrix,
calculating the second channel based on the second channel state information and the second precoding matrix, and
estimating the downlink channel based on the calculated first channel and the calculated second channel.

14. The channel estimation method according to claim 13, wherein
the downlink channel is estimated to be a weighted average of the calculated first channel and the calculated second channel.

15. The channel estimation method according to claim 14, wherein
the first resource is prior to the second resource in time direction, and
a weight of the calculated first channel is not more than a weight of the calculated second channel.

16. The channel estimation method according to claim 11, wherein
the first radio resource and the second radio resource don't overlap in frequency direction.

17. The channel estimation method according to claim 16, wherein
the estimating the downlink channel includes
calculate the first channel based on the first channel state information and the first precoding matrix,
calculate the second channel based on the second channel state information and the second precoding matrix, and
estimate the downlink channel based on the calculated first channel and the calculated second channel.

18. The channel estimation method according to claim 17, wherein
the downlink channel includes a first downlink channel corresponding to the first radio resource and a second downlink channel corresponding to the second radio resource, and
the first downlink channel and the second downlink channel are estimated to be a weighted averages of the calculated first channel and the calculated second channel.

19. The channel estimation method according to claim 18, wherein
for the first downlink channel, a weight of the calculated first channel is more than a weight of the calculated second channel, and
for the second downlink channel, a weight of the calculated first channel is less than a weight of the calculated second channel.

20. The channel estimation method according to claim 11, further comprising:
transmitting information indicating the first radio resource and the second radio resource.
